(19) United States
(12) Patent Application Publication
(10) Pub. No.: US 2001/0036437 A1
(43) Pub. Date: Nov. 1, 2001

(54) Nanoscale pyrogenic oxides

(76) Inventors: Andreas Gutsch, Ranstadt (DE); Thomas Hennig, Gelnhausen (DE); Stipan Katusic, Kelkheim (DE); Michael Kramer, Maintal (DE); Gunther Michael, Karlstein (DE); Geoffrey J. Varga, Freigericht (DE)

Correspondence Address: PILLSBURY WINTHROP LLP, 1600 TYSONS BOULEVARD, MCLEAN, VA, 22102, US

(21) Appl. No.: 09/821,797

(22) Filed: Mar. 30, 2001

Related U.S. Application Data
(60) Provisional application No. 60/194,367, filed on Apr. 4, 2000.

(30) Foreign Application Priority Data
Apr. 3, 2000 (EP) 00 107 237.0

(51) Int. Cl. C04B 35/49; C01F 7/30; C01G 23/047; C01G 25/02

(52) U.S. Cl. 423/610; 423/608; 423/625; 501/103

(57) ABSTRACT

Nanoscale, pyrogenically produced oxides and/or mixed oxides having a BET surface area of between 1 and 600 m²/g and a chloride content of less than 0.05 wt. % are produced by converting organometallic and/or organometalloid substances into the oxides at temperatures of above 200° C.

The oxides may be used as a polishing agent in the electronics industry (CMP).

This invention relates to nanoscale, pyrogenically produced oxides, to a process for the production thereof and to the use thereof.

It is known to produce pyrogenic oxides by flame hydrolysis of vaporisable metal chlorides or metalloid chlorides (Ullmanns Enzyklopadie der technischen Chemie, 4th edition, volume 21, page 44 (1982)).

These products produced in this manner have the disadvantage that, especially in the case of basic oxides, they have elevated chloride contents because they may be deacidified only very incompletely. The following chloride contents are typical of various oxides: titanium dioxide: approx. 3000 ppm, aluminium oxide: approx. 5000 ppm and zirconium oxide: approx. 6000 ppm.

Raising the temperature to higher levels during deacidification is not possible because this would amount to excessive exposure to elevated temperatures and result in an unwanted loss of surface area.

On the other hand, it is desirable that the chloride is removed as completely as possible, as this residual chloride content gives rise to corrosion problems when the oxides are used.

The known process for the production of pyrogenic oxides furthermore has the disadvantage that, for example in the case of aluminium chloride or zirconium tetrachloride, very high vaporisation temperatures must be used in order to be able to convert the starting materials into the gas phase. These vaporisation conditions place extremely stringent and thus very costly demands upon the materials of the production plant. The object thus arises of producing nanoscale, pyrogenic oxides having a low chloride content and a BET surface area of between 1 and 600 m²/g, wherein these disadvantages do not occur.

The present invention provides nanoscale, pyrogenically produced oxides and/or mixed oxides of metals and/or metalloids, which oxides are characterised in that they have a BET surface area of between 1 and 600 m²/g and a total chloride content of less than 0.05%, preferably of less than 0.02 wt. %.

The present invention also provides a process for the production of the nanoscale, pyrogenically produced oxides and/or mixed oxides of metals and/or metalloids, which process is characterised in that organometallic and/or organometalloid substances, optionally dissolved in a solvent, are converted into the oxides, optionally in a flame, at temperatures of above 200° C.

The educts may be organometalloid and/or organometallic pure substances or any desired mixtures thereof or may be used as solutions in organic solvents.

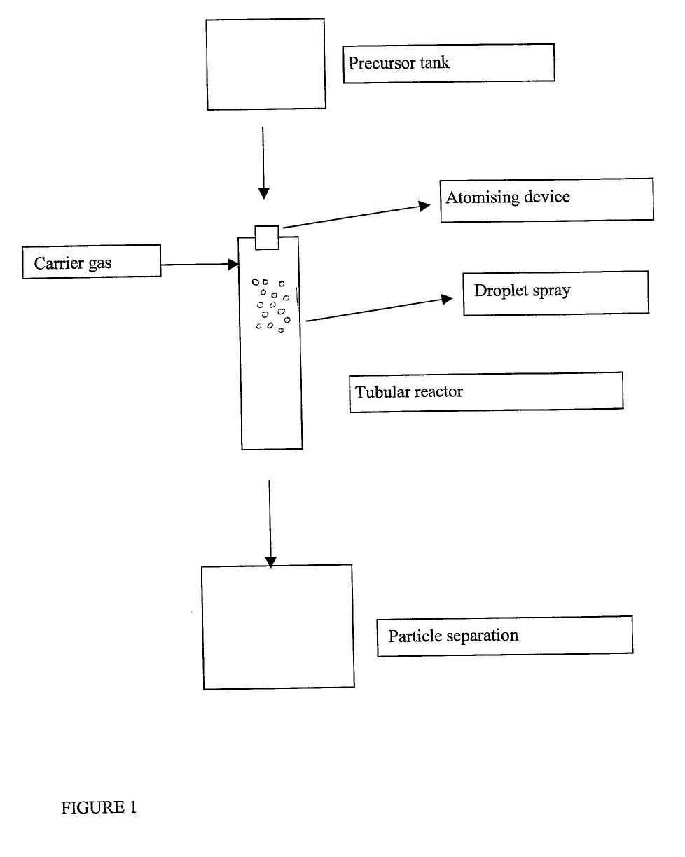

The process according to the invention is shown schematically in FIG. 1.

The following oxides may be produced using the process according to the invention:

Pyrogenically produced monoclinic zirconium oxide having a chloride content of less than 0.05 wt. %.

Pyrogenically produced amorphous aluminium oxide.

Pyrogenically produced alpha aluminium oxide.

Pyrogenically produced titanium oxide having a rutile structure.

Suitable organometallic and/or organometalloid compounds may be fed in liquid form as a very finely divided spray into a high temperature reaction chamber, wherein particle formation may proceed in the high temperature reaction chamber, which preferably takes the form of a closed tubular reactor, at temperatures of above 400° C., wherein inert or reactive gases may additionally be fed into the high temperature reaction chamber as a carrier gas and the powders may be isolated by known gas/solid separation methods by means of a filter, cyclone, scrubber or other suitable separators.

To this end, solutions of organometallic and/or organometalloid substances (precursors) in organic solvents or also the pure substances (precursors) may be converted into the oxides, optionally in a flame, at relatively high temperatures, optionally of above 400° C.

Compounds of the type MeR may be used as precursors, wherein R represents an organic residue, such as for example methyl, ethyl, propyl, butyl, or the corresponding alkoxy variants or also a nitrate ion, and Me means a metal or a metalloid, such as for example Si, Ti, Ce, Al, Zr, Y, B, Ge, W, Nb, In, Sb, Zn, Sn, Fe, Mn, Mg, V, Ni, Cu, Au, Ag or Pt.

Solvents which may be used are organic solvents, such as alcohols, such as for example propanol, n-butanol, isopropanol and/or water.

The precursor may be fed at a temperature of 100 to 1000 bar.

The precursor may be atomised by means of an ultrasound nebuliser.

The temperature may be at least 200° C. for amorphous particles and compact spheres.

Fine particles may be obtained at a temperature of 1800° C. to 2050° C.

One advantage of the process according to the invention is that it is possible to introduce the precursors into the combustion chamber not in gaseous form, but instead in liquid form. In this process, at least one single-fluid nozzle at pressures of up to 3000 bar may produce a very fine droplet spray (average droplet size depending upon nozzle pressure of between 2 and 500 μm), which then combusts, so producing the oxide as a solid.

At least one two-fluid nozzle may furthermore be used at pressures of up to 100 bar.

The droplets may also be produced by using one or more two-fluid nozzles, wherein the gas used in two-fluid atomisation may be reactive or inert.

Using a two-fluid nozzle creates the advantage that the droplets are produced with a gas jet. This gas jet may contain oxygen or nitrogen or other reactive gases of the formula (MeClx, such as for example silicon tetrachloride (Me corresponds to a metal or metalloid), H₂, CH₄). In this manner, it is possible to achieve very intense mixing of the oxidising agent with the precursor. It is also possible to provide an additional fuel feed in the immediate vicinity of the droplets, in the event that the precursor is not reactive or the vapour pressure of the precursor is not sufficiently high to ensure a rapid reaction.

By using organometallic precursors in solvents, homogeneous solvent mixtures of various compounds of the formula MeR (precursors) may straightforwardly be produced in any desired concentration ratios and fed, preferably in liquid form, into a flame, in order to obtain the corresponding low-chloride, pyrogenic mixed oxides. Using the process according to the invention, it is straightforwardly possible to obtain mixed oxides which could previously be synthesised only with difficulty, if at all, due to widely differing vaporisation behaviour of the raw materials.

Another advantage of the process according to the invention is that it is possible not only to mix the liquid precursor with other liquid precursors but also optionally to disperse fine particles, such as for example pyrogenic oxides, such as Aerosil, precipitated silica, in the precursor, such that the particles dispersed in the precursor may be coated during the reaction.

The precursors may preferably be converted into the oxides in an oxyhydrogen flame. Apart from hydrogen, other flammable gases, such as for example methane, propane, ethane, may be used.

Since the organometallic precursors themselves constitute a good fuel, another advantage of the process according to the invention is that it is possible entirely to dispense with the supporting flame, so allowing savings to be made, for example, on hydrogen as a costly raw material.

Moreover, by varying the quantity of air (for combustion) and/or by varying nozzle parameters, it is possible to influence oxide properties, for example the BET surface area.

The low-chloride, pyrogenically produced oxides of metals and/or metalloids according to the invention may be used as a filler, as a support material, as a catalytically active substance, as a starting material for the production of dispersions, as a polishing material for polishing metal or silicon wafers in the electronics industry (CMP), as a basic substance in ceramics, in the cosmetics industry, as an additive in the silicone and rubber industry, for establishing the rheological properties of liquid systems, for providing thermal stabilisation, in the coatings industry as a thermal insulating material, as an antiblocking agent.

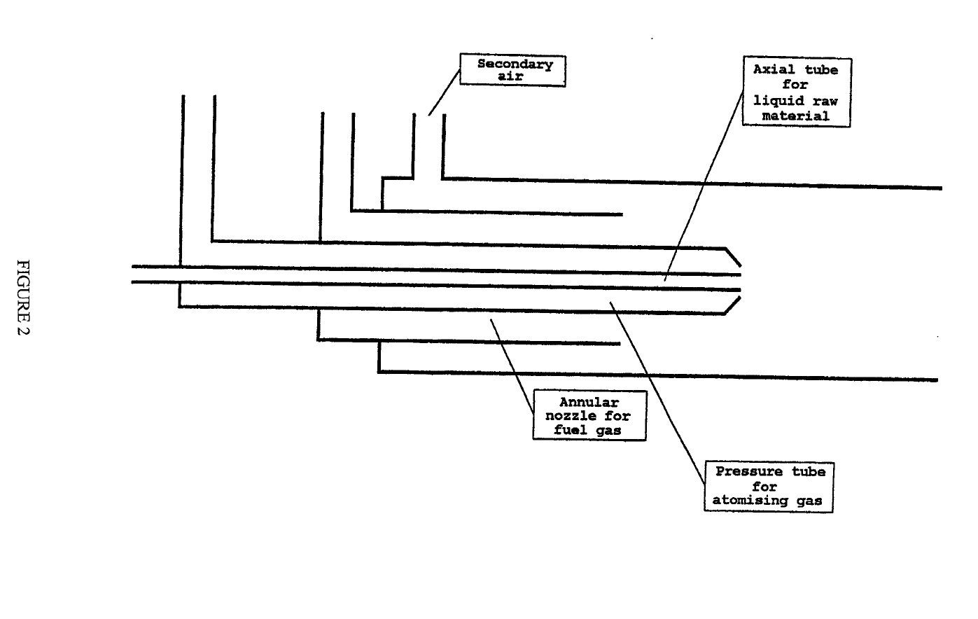

FIG. 2 is a schematic representation of the burner arrangement usable according to the invention.

### EXAMPLE 1

1 l/h of Zr(O—n—C₃H₇)₄ as a 74% solution in n-propanol is atomised into the tubular reactor under nitrogen pressure using a nozzle. An oxyhydrogen flame of hydrogen and air bums in the reactor. The temperature 0.5 m below the flame is 800 to 1000° C. The ZrO₂ is separated in filters. Phase analysis reveals the principal constituent to be monoclinic ZrO₂ having a very low Cl content. As Table 1 shows, the BET surface area may be influenced by varying the nozzle diameter and the quantity of atomising air.

TABLE 1

| | Test 1 | Test 2 | Test 3 |
|---|---|---|---|
| Delivery rate, 1/h | 1 | 1 | 1 |
| Temperature, ° C. | 800-1000 | 800-1000 | 800-1000 |
| V H₂, m³/h | 1.5 | 1.5 | 1.5 |
| V atomising gas, bar | 2 | 7 | 14 |
| V air, m³/h | 13.5 | 16 | 20 |
| Nozzle diameter, mm | 1 | 0.8 | 0.8 |
| BET surface area, m²/g | 18 | 32 | 79 |
| Colour | white | white | white |
| Cl, % | 0.01 | 0.01 | 0.01 |
| Tamped density, g/l | 154 | 154 | |
| Phase analysis | Monoclinic (principal constituent) | | |
| | Tetragonal and cubic | | |
| | (secondary constituent) | | |
| Drying loss, % | 0.5 | | |
| Ignition loss, % | 0.0 | | |
| pH value | 4.6 | | |
| ZrO₂, % | 97.55 | 97.60 | |
| HfO₂, % | 2.14 | 2.14 | |

### EXAMPLE 2

Aluminium nitrate as a 3% (test 1) or 7.5% (test 2) aqueous solution, or liquid aluminium tri-sec.-butylate (tests 3 and 4) are atomised into the tubular reactor with compressed air and a nozzle (diameter 0.8 mm) or in the case of test 2 with an atomiser (diameter 1.1 mm). An oxyhydrogen flame of hydrogen, air and/or oxygen mixture burns in the reactor. The temperature 0.5 m below the flame is 250 to 1250° C. The aluminium oxide is separated in filters. The results are shown in Table 2.

TABLE 2

| | Test 1 | Test 2 | Test 3 | Test 4 |
|---|---|---|---|---|
| Delivery rate, | 320 | 230 | 100 | 120 |
| ml/h | | | | |
| Temperature, | 650-250 | 700-1200 | 560-900 | 1150-1300 |
| ° C. | | | | |
| V H₂, m³/h | 0.6 | 1.5 | 0.9 | 1.6 |
| V atomising | 1.4 | 0 | Two-fluid | 0 |
| gas, carrier gas, | | | nozzle, | |
| bar | | | 0.8 mm | |
| | | | diameter | |
| | | | 2.3 | |
| V air, m³/h | 1.0 | 2.2 | 2.8 | 2.1 |
| BET, m²/g | 3.1 | 9 | 205 | 16 |
| D 50 (Cilas) | 1.52 | 24.7 | 3.47 | 4.52 |
| Phase | 100% | 70% alpha | 16% delta | 100% |
| | amor- | 30% theta | 84% gamma | alpha |
| | phous | | | |
| TEM, μm | Compact | Crystallites | 0.005-0.0010 | |
| | spheres | up to 4 μm | | |
| | 0.2-2 | | | |
| Cl content, % | | 0.018 | | |

### EXAMPLE 3

Titanium bis(ammoniumlactato)dihydroxide ((CH₃CH(O—)CO₂NH₄)₂Ti(OH)₂) as a 50% aqueous solution is atomised into the tubular reactor using compressed air and a nebuliser. An oxyhydrogen flame of hydrogen, air and/or oxygen mixture bums in the reactor. The temperature 0.5 m below the flame is 740 to 1150° C. The titanium oxide is separated in filters. The data are shown in Table 3.

TABLE 3

| | |
|---|---|
| Delivery rate, ml/h | 200 |
| Temperature, °C. | 740-1150 |
| V H₂, m³/h | 1.8 |
| V nebuliser carrier gas, bar | 1.8 |
| V air, m³/h | 1.3 |
| BET, m²/g | 3.1 |
| D 50 (Cilas) | 0.92 |
| Phase | 100% rutile |

1. A nanoscale, pyrogenically produced oxide and/or mixed oxide of metals and/or metalloids, wherein they have a BET surface area of between 1 and 600 m²/g and a total chloride content of less than 0.05 wt. %.

2. A process for the production of nanoscale, pyrogenically produced oxides and/or mixed oxides of metals and/or metalloids as claimed in claim 1, wherein organometallic and/or organometalloid substances, optionally dissolved in a solvent, are converted into the oxides, optionally in a flame, at temperatures of above 200° C.

3. A use of the nanoscale, pyrogenically produced oxides and/or mixed oxides of metals and/or metalloids as a filler, as a support material, as a catalytically active substance, as a starting material for the production of dispersions, as a polishing material for polishing metal or silicon wafers in the electronics industry (CMP), as a basic substance in ceramics, in the cosmetics industry, as an additive in the silicone and rubber industry, for establishing the rheological properties of liquid systems, for providing thermal stabilisation, in the coatings industry as a thermal insulating material, as an antiblocking agent.

4. A pyrogenically produced monoclinic zirconium oxide having a chloride content of less than 0.05 wt. %.

5. A pyrogenically produced amorphous aluminium oxide.

6. A pyrogenically produced alpha aluminium oxide.

7. A pyrogenically produced titanium oxide having a rutile structure.

8. A process as claimed in claim 2, wherein suitable organometallic and/or organometalloid compounds are fed in liquid form as a very finely divided spray into a high temperature reaction chamber, particle formation proceeds in the high temperature reaction chamber, which preferably takes the form of a closed tubular reactor, at temperatures of above 400° C., wherein inert or reactive gases may additionally be fed into the high temperature reaction chamber as a carrier gas and the powders are isolated by known gas/solid separation methods by means of a filter, cyclone, scrubber or other suitable separators.

9. A process as claimed in claim 2, wherein the educts are organometalloid and/or organometallic pure substances or any desired mixtures thereof or are used as solutions in organic solvents.

10. A process as claimed in claim 2, wherein particle formation proceeds by using at least one single-fluid nozzle at pressures of up to 3000 bar.

11. A process as claimed in claim 2, wherein droplet formation proceeds by using one or more two-fluid nozzles, wherein the gas used in two-fluid atomisation may be reactive or inert.
